(19) United States
(12) Patent Application Publication
(10) Pub. No.: US 2008/0166552 A1
(43) Pub. Date: Jul. 10, 2008

(54) Silicone based compositions for thermal interface materials

(75) Inventors: Nathan Andrew Cloud, Wilmington, DE (US); David C. Timpe, Clayton, DE (US); Haibing Zhang, Newark, DE (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: Arlon, Inc.

(21) Appl. No.: 11/981,676

(22) Filed: Oct. 30, 2007

Related U.S. Application Data
(60) Provisional application No. 60/857,070, filed on Nov. 6, 2006.

(51) Int. Cl. C08L 83/04; B32B 9/04; B32B 7/02

(52) U.S. Cl. 428/337; 524/588; 428/447

(57) ABSTRACT

A device is provided herein which comprises first (203) and second (207) substrates, and a composition (205) disposed between the first and second substrates. The composition comprises a continuous phase and a disperse phase, wherein said continuous phase comprises a partially crosslinked polyorganosiloxane having a polymer backbone, and wherein the number of monomeric units in the polymer backbone is within the range of about 2,000 to about 15,000.

### CROSS-REFERENCE TO RELATED APPLICATIONS

The present application claims priority to U.S. Provisional Application Ser. No. 60/857,070 entitled “SILICONE BASED COMPOSITIONS FOR THERMAL INTERFACE MATERIALS, and filed on Nov. 6, 2006, which is incorporated herein by reference in its entirety.

### FIELD OF THE DISCLOSURE

The present disclosure relates generally to thermal interface materials, and more particularly to methods for forming such materials.

### BACKGROUND OF THE DISCLOSURE

Silicone rubber is a unique elastomer that delivers high performance electrical insulation in both low temperature and high temperature environments. Silicone rubber can be precision-calendered to produce coated fabric sheets and specialty extruded tapes for use in products ranging from molded heat shields for aircraft, to substrates for flame retardant ducting and motor coil insulation.

Silicone rubber is particularly useful as a Thermal Interface Material (TIM). TIMs typically take the form of thermally conductive continuous/disperse phase compositions which utilize silicone rubber as the continuous phase, and which are used to facilitate heat transfer between two opposing surfaces. For example, in the fabrication of semiconductor devices, TIMs are commonly used at the interface between a PCB and an adjacent heat sink. Since air has a relatively low thermal conductivity, the use of a TIM to eliminate air gaps between the opposing surfaces in these applications greatly improves thermal transfer efficiency, thus facilitating thermal management of the PCB.

While thermal management is critical to robust assembly design in a wide variety of electronic systems, TIMs also perform other crucial roles in these devices. For example, PCBs used in aerospace and automotive electronic assemblies operate in physically demanding environments, where they are exposed to vibration and temperature extremes. Silicone TIMs are commonly used in such systems not only to bond PCBs to heat sinks but, more generally, to bond dissimilar materials to each other. In addition to providing reliable heat transfer paths that facilitate thermal management, the use of TIMs in these systems provides thermal-mechanical stress decoupling and vibration isolation.

While known silicone rubber TIMs have many advantageous properties, a need exists in the art for silicone rubber TIM compositions with improved performance characteristics. A need also exists in the art for methods of making such compositions. These and other needs may be met with the compositions, devices and methodologies disclosed herein.

### SUMMARY OF THE DISCLOSURE

In one aspect, a device is provided herein which comprises first and second substrates, and a composition disposed between the first and second substrates. The composition comprises a continuous phase and a dispersed phase. The continuous phase comprises a partially crosslinked polyorganosiloxane having a polymer backbone, wherein the number of monomeric units in the polymer backbone is within the range of about 2,000 to about 15,000.

In another aspect, a device is provided herein which comprises (a) first and second substrates, and (b) a composition disposed between the first and second substrates, the composition comprising (a) a partially crosslinked polyorganosiloxane, and (b) fumed titanium dioxide coated with a silane functional coating.

In a further aspect, a device is provided which comprises first and second substrates. A composition is disposed between the first and second substrates, and comprises (a) a polyorganosiloxane, (b) a first filler, and (c) a second filler which is distinct from the first filler. The first and second fillers may be chemically and/or physically distinct from each other.

In another aspect, a method for making a TIM is provided. In accordance with the method, a silicone gum is provided. The silicone gum is mixed with an oxidizing agent or other crosslinking agent to partially crosslink the silicone gum. The partially crosslinked silicone gum is then mixed with a material selected from the group consisting of extended fillers and reinforcing agents.

In still another aspect, a method for producing a filled polymer is provided. In accordance with the method, a polyorganosiloxane is mixed with a primary filler, wherein w_{filler} is the mass of primary filler employed in the composition and is given by the equation

$${w}_{filler} < \frac{\frac{1}{6} π}{1 - \frac{1}{6} π} \frac{{p}_{filler}}{{p}_{silicone}} {w}_{silicone}$$

In this equation, w_{silicone} is the mass of polyorganosiloxane in the composition, p_{filler} is the density of the primary filler, p_{silicone} is the density of the polyorganosiloxane, and w_{filler}, w_{silicone}>0.

### BRIEF DESCRIPTION OF THE DRAWINGS

FIG. 1 is an illustration of some of the benefits of the silicone compositions described herein;

FIG. 2 is an illustration depicting the effect of thermal expansion and contraction of a PCB/heat sink assembly during thermal cycling;

FIG. 3 is an illustration depicting the deformation of a PCB/heat sink assembly due to stress and strain;

FIG. 4 is a flow chart illustrating the steps in one embodiment of the methodology taught herein;

FIG. 5 is a graph of the plasticity of a compound as a function of gum penetration;

FIG. 6 is an illustration of a spherical filler disposed in a continuous phase lattice;

FIG. 7 is an illustration of a spherical filler disposed in a continuous phase lattice which depicts the case of the theoretical maximum filler loading for the primary filler within the continuous phase of a partially crosslinked polymer lattice; and

FIG. 8 is an illustration of a spherical filler disposed in a continuous phase lattice and depicting filler-to-filler separation parameters.

FIG. 9 is a diagram illustrating the factors which govern the compliance of a material.

FIG. 10 is an illustration of a compliance scale.

### DETAILED DESCRIPTION

As used herein, the following terms have the definitions as indicated:

“Dynamic Viscosity” refers to the tangential force per unit area required to move one horizontal plane with respect to another at unit velocity when maintained a unit distance apart by the fluid.

“Cone Penetration of Lubricating Grease” (ASTM D217) refers to the quantity determined by the referenced test method which covers four procedures for measuring the consistency of lubricating greases by the penetration of a cone of specified dimensions, mass, and finish. The penetration is measured in tenths of a millimeter.

“Plasticity” (ASTM D926) refers to the quantity determined by the referenced test method which describes the plasticity and recovery of unvulcanized rubber by means of a parallel plate plastometer.

“Siloxane” refers to the class of silicone compositions with the empirical formula R₁R₂SiO, wherein R₁ and R₂ are organic groups, and wherein Si—O constitutes the polymer backbone.

“Silicone Fluid” refers to a silicone composition having 50 to 2,000 monomer units.

“Silicone Gum” refers to a silicone composition having 2,000 to 15,000 monomer units.

“Silicone Base” refers to a composition containing silicone gum and a reinforcing filler.

“Silicone Compound” refers to a composition containing a silicone base, an extending filler and functional modifiers.

“TIM” refers to a Thermal Interface Material.

“Finished” silicone TIM compounds are silicone TIM compounds which have a plasticity between 1.5 mm to 10.0 mm.

“Uncured Compound Integrity” refers to the ratio of compound cohesive strength over compound adhesive strength to its carrier (typically, it is desirable for the uncured compound integrity to be greater than 1). The numerical value of this quantity provides an indication of the degree to which the referenced compound can be milled, internally mixed, calendered, and extruded without phase separation.

“Calenderable” refers to the characteristic of being able to be processed on three roll calenders without phase separation.

“Extrudable” refers to the property of being able to be processed through a single screw extruder without phase separation.

“Moldable” refers to the property of being able to be processed in a compression or transfer mold without phase separation.

“Extending Filler” refers to a filler used to impart non-reinforcing properties, such as high thermal conductivity, to a silicone polymer.

“Reinforcing Filler” refers to a filler used to impart tensile strength, compression strength, shear strength, and modulus to a compound.

“Functional Modifiers” refers to non-extending or non-reinforcing fillers or components that provide some material functionality to the final compound.

It has now been found that the aforementioned needs in the art may be addressed through the provision of a high consistency, silicone-based composition with rheological properties that are conducive to calendaring, extruding, and molding processes for the manufacture of thermal interface materials (TIMs) having a high thermal conductivity. TIMs may be produced from these materials which have excellent dielectric properties and which have a low shear modulus across a continuous operating temperature range from −100° C. to 200° C.

In a preferred embodiment, the silicone-based compositions comprise (a) 2 to 75% by weight (20 to 25% preferred) of a partially crosslinked phenyl vinyl methyl siloxane, wherein the number of monomeric units in the polymer backbone is within the range of about 2,000 to about 15,000; (b) 0 to 35% by weight of a fumed titanium dioxide reinforcing filler system to aid processing, which may be useful for providing TIM reinforcement and facilitating handling; (c) 35 to 60% by weight of a (preferably optimally packed) combination of spherical, extending filler systems (preferably comprising boron nitride and aluminum oxide); (d) up to 2% by weight silane, which may provide integral coupling and reinforcing properties; less than 2% by weight of an initiating system to facilitate crosslinking; (f) 0 to 5% by weight of a functional filler package, which may include acid neutralizers and flame retardants; (g) 0 to 5% by weight of low molecular weight phenyl vinyl methyl siloxanes, vinyl methyl siloxanes, or dimethyl siloxanes, which may aid compounding and may also be useful in controlling polymer to reinforcement filler structuring.

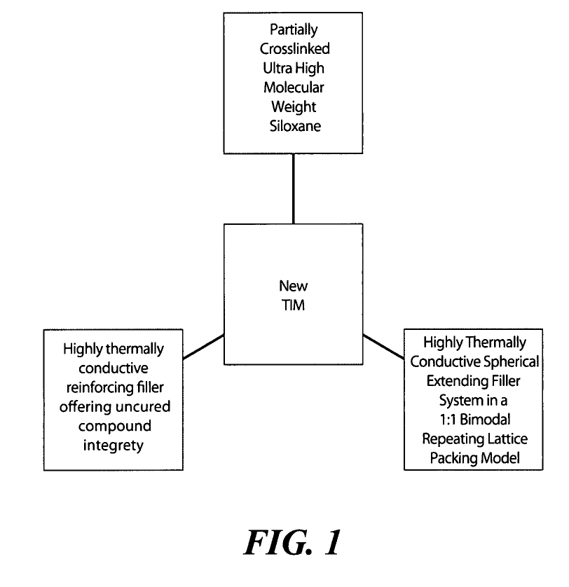

Some important aspects of some of the TIM compositions described herein are summarized in FIG. 1. As seen therein, these compositions preferably comprise an ultra high molecular weight phenylvinylmethyl siloxane (PVMQ) which is made by a partial crosslinking process, and which includes a reinforcing filler. The reinforcing filler has a high thermal conductivity compared to such reinforcing fillers as silica, and imparts uncured compound integrity and physical integrity to the cured TIM. These TIM compositions are also preferably compounded with a highly thermally conductive, spherical extending filler system designed in accordance with a 1:1 bimodal repeating lattice packing model.

Silicone is preferably chosen as the polymer for the continuous phase (or matrix) in TIM compositions of the type disclosed herein, due to its excellent thermal stability, low shear modulus, and good elasticity. These silicone-based TIMs will typically perform one or more of the functions (a)-(d) specified below, depending on the specific end use application in which they are utilized.

### (a) Thermal-Mechanical Decoupling

A heat sink and a semiconductor device (such as a PCB) generally have different Coefficients of Thermal Expansion (CTEs). Consequently, during thermal cycling, the semiconductor device and heat sink tend to expand and contract at different rates and in different amounts. This CTE mismatch produces stress and strain on the semiconductor device, which can damage the device or its components.

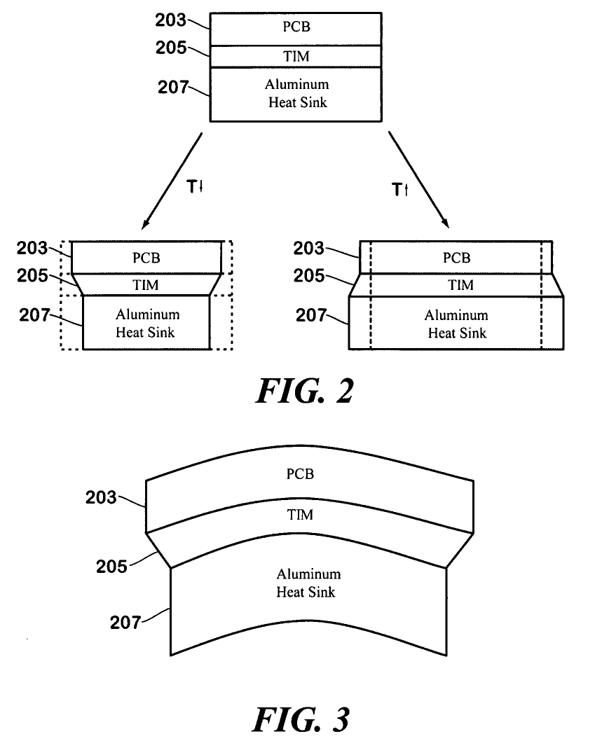

This effect is illustrated in FIGS. 2-3. The device depicted therein comprises a PCB 203 and an aluminum heat sink 207 which have a silicone-based TIM 205 disposed between them. As seen therein, the components of the device respond differently to thermal cycling. Thus, during the cooling phase of the thermal cycle, the heat sink 207 contracts at a faster rate than the PCB 203. Likewise, during the heating phase of the thermal cycle, the heat sink 207 expands at a greater rate than the PCB 203.

The silicone-based TIM 205 compensates for this CTE mismatch by providing a compliant interface between the two substrates. In particular, the silicone-based TIM 205 can be made with a much lower shear modulus than either the PCB 203 or the heat sink 207. Consequently, during both phases of the thermal cycle, the compliance of the TIM permits decoupling of the mismatched CTEs, thereby reducing or preventing damage caused by the stress or strain attendant to the CTE mismatch.

### (b) Adhesion of a Semiconductor Device to a Substrate

The coupling of semiconductor devices (such as PCBs) to substrates (such as fixed heat sink platforms) is particularly critical in mobile environments of the type found in automotive and aerospace applications. Good TIM shear strength is necessary in such applications in order to maintain the device or component in a fixed position.

### (c) Heat Dissipation

Thermally conductive TIMs provide an efficient heat transfer path between semiconductor devices (such as PCBs) and heat sinks. This thermally conductive path greatly facilitates the thermal management of the device.

### (d) Electrical Insulation

Electrically insulating TIMs can protect semiconductor devices (such as PCBs) from dielectric breakdown or leakage current, thereby reducing or eliminating the incidence of electrical faulting between the device and a heat sink in an electronic assembly.

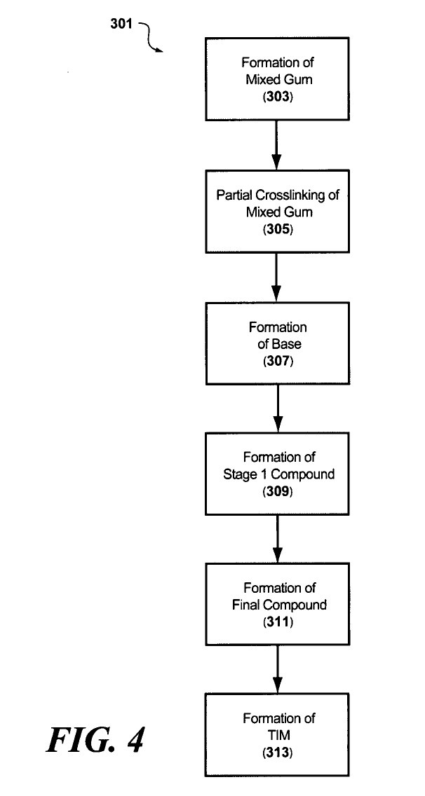

The general process 301 by which TIM compositions of the type disclosed herein may be synthesized may be understood with reference to FIG. 4. As shown therein, the initial step of the process involves the formation of a mixed gum 303. This is typically accomplished by mechanically mixing silicone gum with a suitable crosslinking agent (preferably a peroxide). The mixed gum is then partially crosslinked 305, as through exposure to ultraviolet radiation, heat, or another suitable energy source. A base is then formed 307 by mechanically mixing the partially crosslinked gum with a suitable reinforcing filler.

A stage 1 compound is then formed 309 by mixing the base with a reinforcing agent (such as TiO₂) and/or with an extending filler package. The final compound is then formed 311 by mixing the stage 1 compound with functional additives and peroxide or another suitable crosslinking agent. The TIM is then produced 313 from the final compound through suitable extrusion, calendaring and/or molding processes.

As noted in the particular embodiment of the methodology depicted in FIG. 4, one significant feature of some of the methods described herein is the use of partial crosslinking to increase the perceived molecular weight (or intrinsic viscosity) of the silicone gum. It has been found that such crosslinking can increase the effective molecular weight of the silicone gum beyond the maximum molecular weights found in commercially available silicone gum compositions. This, in turn, can significantly improve thermally conductive filler absorption, thus allowing optimal amounts of such fillers to be used in silicone gum compositions.

It is known in the art that the bulk thermal conductivity of silicone compounds may be improved by incorporating thermally conductive extending fillers into the silicone gum precursors of these compounds. Typically, this is accomplished through the use of a mill, an internal mixer, or twin screw extruder. However, it is important, in targeting the bulk thermal conductivity of a silicone compound, to optimize the molecular weight (or molecular weight distribution) of the silicone so that the mixed compound can be easily processed downstream into a final TIM product. The targeted molecular weight (or molecular weight distribution) must take into account the additional components that are typically added to a stage 1 compound in order to produce the final TIM (see the general methodology depicted in FIG. 4). These components may include reinforcing fillers, initiators, functional modifiers, and other such components.

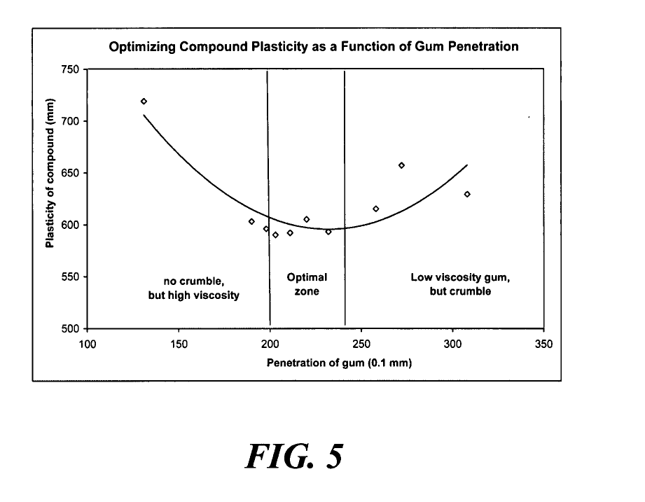

The targeted bulk thermal conductivity requirement of a compound typically requires that a given volume percent of highly thermally conductive filler content be interspersed with the continuous phase gum. However, as indicated in FIG. 5, there is often a relatively small range of gum molecular weights that can absorb the required filler content while still remaining processable. Outside of this range, the mixed compound will typically either have such a high plasticity that post processing of the final TIM product is not possible (indicated by the region below a penetration value of 2.00 mm in the particular example depicted), or else the gum will be unable to absorb the amount of extending filler required to reach the desired bulk thermal conductivity (indicated by the region above a penetration value of 2.40 mm in the particular example depicted). The latter failure mode may be manifested by crumbling of the compound or by phase separation.

Various methods may be used for producing a silicone polymer with a molecular weight that is suitable to absorb the quantity of extending filler required to meet the bulk thermal conductivity requirements for the mixed compound. For example, the silicone polymer may be synthesized to provide a desired molecular weight based on chain length, or else commercially available silicone liquids and gums may be blended together to provide a desired average molecular weight. However, the maximum molecular weights of silicone TIMs that are achievable by these methods are ultimately dictated by the process limitations of the synthetic routes utilized to synthesize linear silicone polymers.

It has now been found that these limitations may be overcome through the use of partial crosslinking to increase the average molecular weight (or intrinsic viscosity) of silicone polymers in TIMs beyond the levels currently achievable by existing synthetic routes, thereby optimizing thermally conductive filler absorption while maintaining good compound processability. In particular, methods are disclosed herein for partially crosslinking high molecular weight silicone gums (preferably within the range of about 2,000 to about 15,000 monomer units per siloxane chain) with an organic peroxide or other suitable crosslinking agent. The partial crosslinking of these gums adds polymer structure through the creation of additional chemical bonds, whereas non-partially crosslinked silicone gums typically consist of linear polymeric chains which are loosely entangled but not chemically bonded to each other.

Preferably, the partial crosslinking described above is achieved with an organic peroxide. Organic peroxides that may be suitable for this purpose include, but are not limited to, bis(2,4 dichlorobenzoyl) peroxide, benzoyl peroxide, t-butyl perbenzoate, di-t-butyl peroxide, 2,5-dimethyl-2,5-di(t-butylperoxy)hexane, and dicumyl peroxide. The peroxide is typically premixed into the silicone gum at a weight ratio (organic peroxide to gum) within the range of about 1×10⁻⁶:1 to about 0.1:1. Preferably, the peroxide is premixed into the silicone gum at a weight ratio within the range of about 1×10⁻⁵:1 to about 0.01:1, more preferably within the range of about 4×10⁻⁴:1 to about 2×10⁻³:1, and most preferably within the range of about 2×10⁻⁴: 1 to about 2×10⁻²:1.

The organic peroxide is preferably mixed into the silicone gum using a two roll mill or internal mixer, and the silicone is subsequently crosslinked at elevated temperatures (preferably within the range of about 190° F. to about 350° F., and more preferably within the range of about 230° F. to about 310° F.), with dwell times within the range of about 1 to about 5 hours, and more preferably within the range of about 2 to about 4 hours. Of course, one skilled in the art will appreciate that optimal crosslinking temperatures and dwell times may vary, depending on such factors as the ratio of crosslinking agent to silicone gum, the quantity of gum, the degree of partial crosslinking desired, and the particular laboratory or production equipment used.

Once it is partially crosslinked, the gum is ready for combining with thermally conductive extending filler packages. This is preferably accomplished using a two roll mill or an internal mixer. In addition to the extending filler addition, the mixed gum may be further processed through the addition of functional modifiers, reinforcing fillers, and additional peroxide to complete the compound mixing process. Final vulcanization is typically utilized to complete the fabrication of the TIM.

Without wishing to be bound by theory, it is believed that partially crosslinked silicone creates an optimal zone for absorbing the required filler loading, while maintaining compound plasticity at levels suitable for robust post processing through calendars, extruders, molding equipment, and the like. By maximizing the adsorption of the thermally conductive filler system into the partially crosslinked gum, a silicone TIM is obtained which has a high bulk thermal conductivity and which facilitates good heat transfer in end use applications. Additionally, the silicone TIM can be processed into a workable, homogeneous form suitable for use in vulcanized and unvulcanized calendered sheets, extruded tapes, and molded parts. Unvulcanized final parts can be made from the silicone TIMs which have a compound integrity value greater than one. Such compound integrity values facilitate application handling. Vulcanized final parts can be made from the silicone TIMs which have good compliance and no phase separation, the latter of which may be exhibited by the absence of crumbling.

It has also been found that the shape and geometric packing arrangement of fillers within the partially crosslinked gum can, in some embodiments, be an important factor in (a) maximizing the bulk thermal conductivity of the compound, (b) ensuring that the compound is sufficiently processable by conventional manufacturing equipment, and (c) ensuring that the compound has suitable compound integrity and plasticity for its intended application. To this end, a bimodal geometric packing arrangement has been developed. This packing arrangement features spherical extending fillers with high bulk thermal conductivity which are dispersed into a continuous phase, partially crosslinked silicone gum. The thermally conductive extending filler preferably comprises both primary and secondary spherical fillers. The primary and secondary spherical filler combination is preferably selected from the group consisting of boron nitride/boron nitride, boron nitride/aluminum oxide, aluminum oxide/boron nitride, and aluminum oxide/aluminum oxide filler combinations.

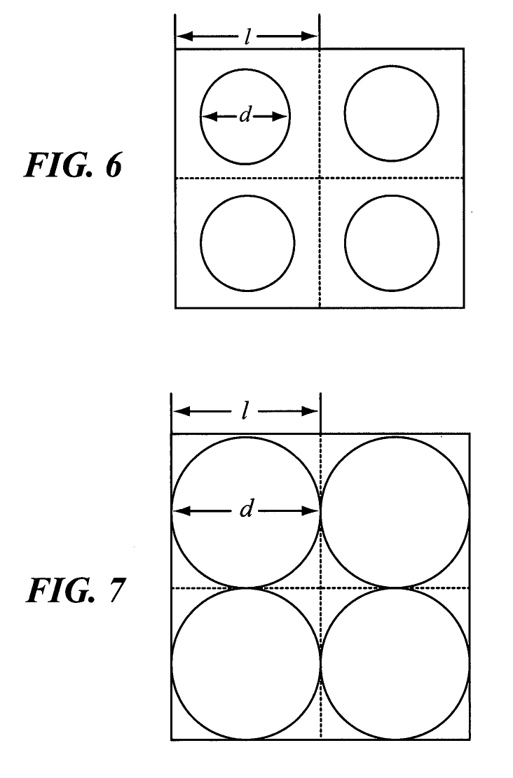

The combination of extending filler spheres are arranged in the continuous polymer phase unit lattice so as to maximize compound thermal conductivity while minimizing compound plasticity. The weight limits of the primary and secondary fillers for a given unit lattice of continuous phase polymer is defined by the morphology model of the spherical extending filler pairs. These models are described with reference to FIGS. 6-8 as follows.

Assuming that a primary spherical filler occupies one continuous phase lattice (FIG. 6), then EQUATION 1 can be derived:

$$\frac{{w}_{filler} {p}_{silicone}}{{w}_{silicone} {p}_{filler}} = \frac{\frac{1}{6} π {d}^{3}}{{l}^{3} - \frac{1}{6} π {d}^{3}} \qquad ( EQUATION 1 )$$

In EQUATION 1, the weight w_{silicone} and density p_{silicone} of the partially crosslinked silicone continuous phase, and the weight w_{filler} and density p_{filler} of the extending filler, are related to the morphology parameters of primary filler diameter d and unit lattice length l. The theoretical maximum filler loading for the primary filler within the continuous phase of partially crosslinked polymer lattice occurs when d approaches l (see FIG. 7). If the primary filler diameter d is greater than l, the compound will phase separate. Therefore, EQUATION 2 may be used to calculate the theoretical maximum primary filler loading by weight in a unit lattice of continuous phase partially crosslinked polymer:

$${w}_{filler} < \frac{\frac{1}{6} π}{1 - \frac{1}{6} π} \frac{{p}_{filler}}{{p}_{silicone}} {w}_{silicone} \qquad ( EQUATION 2 )$$

Once the theoretical maximum primary filler loading weight is determined, EQUATION 3 may be used to determine the lattice dimension l:

$${l}^{3} = \frac{1}{6} π {d}^{3} ( 1 + \frac{{w}_{silicone} {p}_{filler}}{{w}_{filler} {p}_{silicone}} ) \qquad ( EQUATION 3 )$$

Hence, the lattice dimension is given by:

$$l = {( \frac{1}{6} π {d}^{3} ( 1 + \frac{{w}_{silicone} {p}_{filler}}{{w}_{filler} {p}_{silicone}} ) )}^{1 / 3} \qquad ( EQUATION 4 )$$

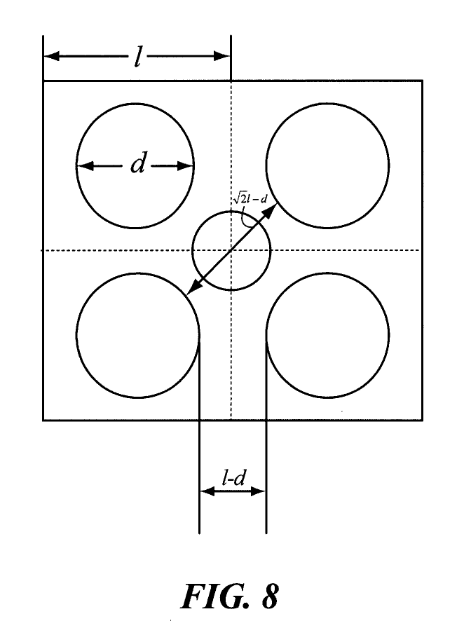

Finally, the calculation of primary filler to filler separation parameters is determined from FIG. 8 to be l−d and \sqrt{2}l−d.

Given the weight and density of the partially crosslinked silicone continuous phase, and the density of the primary extending filler, the theoretical weight of the primary filler for maximum compound packing without phase separation is determined. The theoretical compound lattice volume and dimensions are determined to define the primary filler-to-filler separation parameters which determine the packing space remaining and, ultimately, the diameter of the secondary spherical filler. The loading weight of the secondary filler for the continuous phase lattice volume is determined by the secondary filler sphere diameter, specific gravity, and an understanding that, for every primary filler sphere in the continuous phase lattice, there is also one secondary filler sphere within that lattice.

Silicone compounds employ the use of reinforcing fillers to improve the manufacturing processibility of silicone bases and compounds, as well as to impart functional properties to the silicone compounds which are tailored to specific end use applications. The reinforcing filler of choice for most manufacturers has typically been fumed silicon dioxide or precipitated silicon dioxide. These reinforcing fillers impart adequate green strength to uncrosslinked silicone bases so that they have sufficient consistency to be processed with calendars, extruders, and molding equipment. Reinforcing fillers also impart improved strength (tension, compression, and shear) and modulus to a fully crosslinked elastomer as final compound properties. The physical properties of the elastomer may be tailored by the quantity and type of reinforcing filler, as well as by the surface treatment of the filler.

The addition of silica reinforcing fillers can also have detrimental and limiting affects on the final compound. These effects include very high uncrosslinked plasticity, which can limit conventional post-processing of the compound. For example, the use of such reinforcing fillers may cause the compound to be too stiff for feeding through calendar nips, extruder screws, or molding equipment. Additionally, the reinforcing filler can take up volumetric space in the partially crosslinked silicone base and limit the quantity of thermally conductive extending filler volume in the final compound. This can have the effect of limiting the bulk thermal conductivity of the silicone compound, since the reinforcing filler generally has lower thermal conductivity than the extending filler system.

In some embodiments of the devices, methodologies and compositions described herein, fumed titanium dioxide coated with an organofunctional silane coating is incorporated into the partially crosslinked silicone gum as a replacement for conventional silica materials. The initial benefit of this filler is that it has a bulk thermal conductivity which is two times greater than silica. This, in turn, can translate into greater bulk thermal conductivities of the final silicone TIM compound.

The fumed, silane coated reinforcing filler also facilitates extending filler addition by increasing gum integrity, which in turn may increase the amount of extending filler that can be added to the gum without inducing phase separation. Substantial quantities of the silane coated fumed titanium dioxide (for example, up to 400 parts by weight per 100 parts of partially crosslinked gum) can be incorporated into the gum to achieve a silicone base that can accept, through dispersion, larger amounts of extending filler than comparable gums not compounded with a silane coated fumed titanium dioxide filler. In many cases, the plasticity of the final compound is found to be virtually unchanged, even with the addition of substantial quantities of reinforcing filler.

As a further advantage, in many cases it is found that the (preferably nano-sized) silane coated reinforcing filler also does not disrupt the calculated extending filler packing. Without wishing to be bound by theory, this is believed to be due to the ability of the filler to easily assimilate into the partially crosslinked gum. As such, the silane coated reinforcing filler acts as an integral part of the continuous polymer phase to suspend the extending filler package.

The compositions and methodologies described herein may be used in conjunction with a wide variety of substrates. For example, TABLE 1 below lists some possible substrates for which the compositions described herein may be utilized as TIMs:

TABLE 1
Possible Assembly Substrates

Heat Sink Materials and Treatments
Aluminum Bright
Aluminum Epoxy Paint
Aluminum Anodized Black
Aluminum Anodized Gold
Aluminum Anodized Clear
Aluminum Epoxy Prepreg
Aluminum Chromate
Carbon Monolithic
Ceramics
Stainless Steel, PC Steel
Copper, CMC, CIC, Brass
Anodized Aluminum - Chromic Acid, Sealed and Unsealed
Anodized Aluminum - Sulfuric Acid, Sealed and Unsealed
Gold
PCB Materials and Treatments
Polyimide
Multi-functional Epoxy
BT Epoxy
FR-4
Ceramics
Copper Foil
Tin-Lead Solder
HASL Surfaces
Palladium
Epoxy-based Solder Mask
Epoxy/Acrylic-based Solder Mask

As indicated above, the compositions described herein may be used with such substrates as calendered, extruded, or molded high consistency, silicone-based TIMs, and may further be used to mate such substrates together or to bond them to another substrate or surface. In such applications, the compositions described herein may serve to (a) provide a high thermal energy transfer path between substrates, (b) connect the substrates together while decoupling induced stress and subsequent strain between the substrates as caused by CTE mismatches, and (c) provide electrical insulation between the substrates. In many cases, the compositions described herein will offer these properties over temperatures within the range of about −100° C. to about 200° C. Assembly substrates include, but are not limited to, combinations of polymeric resin filled composite printed circuit boards and metallic heat sinks.

Various fillers may be used in the compositions, methodologies and devices described herein, either alone or in combination with one or more of the fillers described herein. These include (a) thermally conductive, dielectric fillers, (b) fillers that are both thermally and electrically conductive, and (c) fillers that are neither thermally nor electrically conductive. Such fillers may include, without limitation, aluminum oxide, aluminum nitride, magnesium oxide, zinc oxide, boron nitride (including agglomerates of hexagonal boron nitride platelets), boron carbide, titanium carbide, silicon carbide, diamond, ground quartz, zirconium oxide, chromium oxide, beryllium oxide, titanium dioxide, silver (including silver powders, spherical, silver flakes, and colloidal silver), copper, nickel, iron, stainless steel, graphite, and various combinations and sub-combinations of the foregoing.

Various polyorganosiloxanes may be used in the compositions, methodologies and devices described herein. These include, without limitation, polyorganosiloxanes which are formed from curable compositions by hydrosilation reactions, condensation reactions, or free radical reactions. Such curable compositions may have a linear, branched, partially branched linear, or dendritic configurations. In addition, such curable compositions may comprise homopolymers having any of the aforementioned molecular structures, copolymers derived from polymers having any of the aforementioned molecular structures, or mixtures of such homopolymers or copolymers.

Hydrosilation-curable compositions which may be used to form polyorganosiloxanes in accordance with the teachings herein will typically contain silicon-bonded alkenyl groups. Examples of such silicon-bonded alkenyl groups include, without limitation, vinyl, allyl, butenyl, pentenyl, and hexenyl groups. These compositions may also contain other silicon-bonded groups including, without limitation, methyl, ethyl, propyl, butyl, pentyl, hexyl, and other alkyl groups; cyclopentyl, cyclohexyl, and other cycloalkyl groups; phenyl, tolyl, xylyl, and other aryl groups; benzyl, phenetyl, and other aralkyl groups; and 3,3,3-trifluoropropyl, 3-chloropropyl, and other halogenated alkyl groups.

Examples of organopolysiloxanes suitable for use in the hydrosilation-curable silicone compositions include, without limitation, dimethylpolysiloxanes having both terminal ends of the molecular chain blocked by dimethylvinylsiloxy groups, dimethylpolysiloxanes having both terminal ends of the molecular chain blocked by methylphenylvinylsiloxy groups, methylphenylsiloxane-dimethylsiloxane copolymers having both terminal ends of the molecular chain blocked by dimethylvinylsiloxy groups, methylvinylsiloxane-dimethylsiloxane copolymers having both terminal ends of the molecular chain blocked by dimethylvinylsiloxy groups, methylvinylsiloxane-dimethylsiloxane copolymers having both terminal ends of the molecular chain blocked by trimethylsiloxy groups, methyl(3,3,3-trifluoropropyl)polysiloxanes having both terminal ends of the molecular chain blocked by dimethylvinylsiloxy groups, methylvinylsiloxane-dimethylsiloxane copolymers having both terminal ends of the molecular chain blocked by silanol groups, methylphenylsiloxane-methylvinylsiloxane-dimethylsiloxane copolymers having both terminal ends of the molecular chain blocked by silanol groups, and organosiloxane copolymers comprising siloxane units having any of the formulas (CH₃)₃SiO_{1/2}, (CH₃)₂(CH₂═CH)SiO_{1/2}, CH₃SiO_{3/2}, and (CH₃)₂SiO.

When the polyorganosiloxane is formed from a condensation-curable organopolysiloxane, the organopolysiloxane preferably has at least two silanol groups or silicon-bonded hydrolyzable groups in one molecule. Some particular, non-limiting examples of silicon-bonded hydrolyzable groups include methoxy, ethoxy, propoxy, and other alkoxy groups; vinyloxy and other alkenoxy groups; methoxyethoxy, ethoxyethoxy, methoxypropoxy and other alkoxyalkoxy groups; acetoxy, octanoyloxy and other acyloxy groups; dimethylketoxime, methylethylketoxime, and other ketoxime groups; isopropenyloxy, 1-ethyl-2-methylvinyloxy and other alkenyloxy groups; dimethylamino, diethylamino, butylamino, and other amino groups; dimethylaminoxy, diethylaminoxy, and other aminoxy groups; N-methylacetamide, N-ethylacetamide, and other amide groups.

The organopolysiloxane may also contain groups other than silanol or silicon-bonded hydrolyzable groups. Such other groups may include, without limitation, methyl, ethyl, propyl, and other alkyl groups; cyclopentyl, cyclohexyl, and other cycloalkyl groups; vinyl, allyl, and other alkenyl groups; phenyl, naphthyl, and other aryl groups; and 2-phenylethyl and other aralkyl groups.

Various organopolysiloxanes may be used in the condensation-curable compositions described herein. Such organopolysiloxanes include, without limitation, dimethylpolysiloxanes having both terminal ends of the molecular chain blocked by silanol groups, methylphenylsiloxane-dimethylsiloxane copolymers having both terminal ends of the molecular chain blocked by silanol groups, dimethylpolysiloxanes having both terminal ends of the molecular chain blocked by trimethoxysiloxy groups, methylphenylsiloxane-dimethylsiloxane copolymers having both terminal ends of the molecular chain blocked by trimethoxysilyl groups, dimethylpolysiloxanes having both terminal ends of the molecular chain blocked by methyldimethoxysiloxy groups, dimethylpolysiloxanes having both terminal ends of the molecular chain blocked by triethoxysiloxy groups, and dimethylpolysiloxanes having both terminal ends of the molecular chain blocked by trimethoxysilylethyl groups.

When the curable composition is free radical-curable composition, it is preferable to use an organopolysiloxane in the composition which has at least one silicon-bonded alkenyl group per molecule. Some particular, non-limiting examples of silicon-bonded groups which may be present in the organopolysiloxane include ethyl, propyl, butyl, pentyl, hexyl, and other alkyl groups; cyclopentyl, cyclohexyl, and other cycloalkyl groups; vinyl, allyl, butenyl, pentenyl, hexenyl, and other alkenyl groups; phenyl, tolyl, xylyl, and other aryl groups; benzyl, phenetyl, and other aralkyl groups; and 3,3,3-trifluoropropyl, 3-chloropropyl, and other halogenated alkyl groups. Of these groups, alkyl, alkenyl, and aryl are preferred, and methyl, vinyl, and phenyl as particularly preferred.

Examples of organopolysiloxanes which may be suitable for use in the free radical-curable compositions of the present invention include, without limitation, dimethylpolysiloxanes having both terminal ends of the molecular chain blocked by dimethylvinylsiloxy groups, dimethylpolysiloxanes having both terminal ends of the molecular chain blocked by methylphenylvinylsiloxy groups, methylphenylsiloxane-dimethylsiloxane copolymers having both terminal ends of the molecular chain blocked by dimethylvinylsiloxy groups, methylvinylsiloxane-dimethylsiloxane copolymers having both terminal ends of the molecular chain blocked by dimethylvinylsiloxy groups, methylvinylsiloxane-dimethylsiloxane copolymers having both terminal ends of the molecular chain blocked by trimethylsiloxy groups, methyl(3,3,3-trifluoropropyl)polysiloxanes having both terminal ends of the molecular chain blocked by dimethylvinylsiloxy groups, methylvinylsiloxane-dimethylsiloxane copolymers having both terminal ends of the molecular chain blocked by silanol groups, methylphenylsiloxane-methylvinylsiloxane-dimethylsiloxane copolymers having both terminal ends of the molecular chain blocked by silanol groups, and organosiloxane copolymers comprising siloxane units represented by the formulas (CH₃)₃SiO_{1/2}, (CH₃)₂(CH₂═CH)SiO_{1/2}, CH₃SiO_{3/2}, and (CH₃)₂SiO.

Various end products can be made with the compositions and methodologies described herein. These include, without limitation, uncured bulk compounds which may be molded into TIM parts, formed into TIM putties, or utilized to fabricate cured, extruded TIM components; calendared, uncured TIM sheet goods which may be supported or unsupported, and which include uncured TIM adhesives; calendared, cured TIM sheet goods which may be supported or unsupported, and which include cured TIM pads for use in various applications; and cured, extruded TIM tapes and pads.

The methodologies described herein may be used to make highly thermally conductive silicone compounds with a preferred uncrosslinked integrity for processing. These compounds may be fabricated into compliant, crosslinked, highly thermally conductive TIMs. The resulting TIMs are not only highly thermally conductive and have an uncured consistency to allow processing, but also have the functionality of a compliant elastomer. In other words, these TIMs can be manipulated (e.g., flexed, compressed, elongated, or torsioned) and can absorb energy without fracture, rupture or irreversible damage.

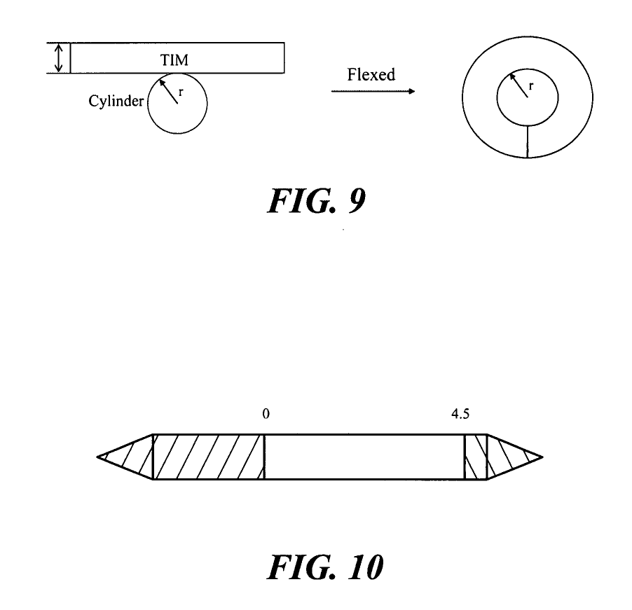

The compliance of these TIMs can be quantified by EQUATION 5 below

$$r = \frac{1 - ɛ}{2 ɛ} t \qquad ( EQUATION 5 )$$

wherein r is the bend radius measured to the inside curvature of the TIM and is the minimum radius a TIM can be flexed physically without damaging the TIM, ∈ is the TIM elongation, and t is the TIM thickness. These parameters may be further understood with reference to FIG. 9.

The bend radius r provides a general indication of the compliance (flexibility) of a TIM material. In particular:
A smaller value for r corresponds to greater compliance (flexibility) in the TIM;
if r<0 or ∈>100%, the TIM is completely compliant (flexible); and
if r>0 or ∈<100%, compliance (flexibility) is limited.

In order to better define the TIM compliance parameter, the theoretical bend radius r may be normalized to TIM thickness to develop the compliance ratio r/t defined in EQUATION 6 below:

$$\frac{r}{t} = \frac{1 - ɛ}{2 ɛ} \qquad ( EQUATION 6 )$$

A compliance ratio scale may then be derived which determines TIM compliance for highly thermally conductive elastomers, using the fact that the compliance ratio r/t is simply a function of the elastomer elongation C measured in accordance with ASTM D412.

The derived compliance scale is depicted in FIG. 10. On that scale, the red area (represented by the cross-hatched area on the left of the diagram) equates to poor TIM compliance (r/t>4.5), the green area (represented by the middle portion of the diagram) equates to the preferred TIM compliance (4.5≧r/t≧0), and the blue area (represented by the cross-hatched portion on the right of the diagram) equates to the ideal TIM compliance (r/t≦0). Preferably, the highly thermally conductive TIMs described herein will have a compliance ratio (r/t) in the green area and, as thermal conductivity is decreased in the range of standard silicones, the r/t ratio moves into the blue area.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A device, comprising:
first and second substrates; and
a composition disposed between said first and second substrates, said composition comprising a continuous phase and a disperse phase;
wherein said continuous phase comprises a partially crosslinked polyorganosiloxane having a polymer backbone, and wherein the number of monomeric units in the polymer backbone is within the range of about 2,000 to about 15,000.

2. The device of claim 1, wherein said composition is a thermal interface material (TIM).

3. The device of claim 1, wherein said disperse phase comprises a material selected from the group consisting of titanium dioxide and spherical aluminum oxide.

4. The device of claim 1, wherein the bulk thermal conductivity of the composition is within the range of about 0.5 W/mK to about 4.0 W/mK at 100° C.

5. The device of claim 4, wherein the plasticity of the composition is within the range of about 2.0 mm to about 10.0 mm.

6. The device of claim 4, wherein the plasticity of the composition is within the range of about 5.0 mm to about 7.0 mm.

7. The device of claim 1, wherein the shear modulus of the composition is within the range of about 5 to about 20% strain below 400 psi.

8. The device of claim 1, wherein said composition comprises about 20% to about 25% by weight of a partially crosslinked phenyl vinyl methyl siloxane.

9. The device of claim 1, wherein said composition comprises about 10 to about 25% by weight of a titanium dioxide filler.

10. The device of claim 1, wherein said composition comprises about 35 to about 60% by weight of a spherical, extending filler system.

11. The device of claim 10, wherein said spherical, extending filler system comprises boron nitride and aluminum oxide.

12. The device of claim 1, wherein said composition comprises about 1% to about 2% of a silane.

13. The device of claim 1, wherein said composition comprises from about 0.5 to about 2% by weight of said crosslinking agent.

14. The device of claim 1, wherein said composition comprises about 2 to about 3% by weight of an acid neutralizer.

15. The device of claim 1, wherein said composition comprises about 2 to about 3% by weight of a flame retardant.

16. The device of claim 1, wherein said composition comprises about 2 to about 5% by weight of a low molecular weight siloxane selected from the group consisting of phenyl vinyl methyl siloxanes, vinyl methyl siloxanes, and or dimethyl siloxanes.

17. The device of claim 1, wherein said first substrate is a printed circuit board (PCB), and wherein said second substrate is a heat sink.

18. The device of claim 17, wherein said heat sink comprises a material selected from the group consisting of aluminum, monolithic carbon, ceramics, stainless steel, copper, and gold.

19. The device of claim 17, wherein said composition has a compliance ratio r/t given by
$$\frac{r}{t} = \frac{1 - ɛ}{2 ɛ}$$
wherein r is the bend radius measured to the inside curvature of the composition, t is the thickness of the composition, and E is the elongation; and wherein r/t is less than about 4.5.

20. The device of claim 19, wherein r/t is less than about 0.

21. A device, comprising:
first and second substrates; and
a composition disposed between said first and second substrates, said composition comprising (a) a polyorganosiloxane, and (b) fumed titanium dioxide coated with a organofunctional functional silane coating.

22. The device of claim 21, wherein the composition is essentially devoid of silica.

23. A device, comprising:
first and second substrates; and
a composition disposed between said first and second substrates, said composition comprising (a) a polyorganosiloxane, (b) a first filler, and (c) a second filler which is distinct from said first filler.

24. A method for making a TIM, comprising:
providing a silicone gum;
partially crosslinking the silicone gum; and
mixing the partially crosslinked silicone gum with a material selected from the group consisting of extended fillers and reinforcing agents.

25. A method for producing a filled polymer, comprising:
mixing a polyorganosiloxane with a primary filler;
where w_{pfiller} is the mass of primary filler employed in the composition and is given by the equation
$${w}_{pfiller} < \frac{\frac{1}{6} π}{1 - \frac{1}{6} π} \frac{{p}_{pfiller}}{{p}_{silicone}} {w}_{silicone}$$
wherein w_{silicone} is the mass of polyorganosiloxane in the composition, wherein p_{pfiller} is the density of the primary filler, wherein p_{silicone} is the density of the polyorganosiloxane, and wherein w_{pfiller}, w_{silicone}>0.
